(19) United States
(12) Patent Application Publication
(10) Pub. No.: US 2025/0289347 A1
(43) Pub. Date: Sep. 18, 2025

(54) VEHICLE THERMAL MANAGEMENT SYSTEM

(71) Applicants: HYUNDAI MOTOR COMPANY, Seoul (KR); KIA CORPORATION, Seoul (KR)

(72) Inventors: Dae Ki Hong, Hwaseong-si (KR); Jae Kwon Lee, Hwaseong-si (KR); Seok Jin Hong, Hwaseong-si (KR); Ki Hoon Kim, Ansan-si (KR); Jae Woong Kim, Hwaseong-si (KR); Se Kyu Oh, Guri-si (KR)

(73) Assignees: HYUNDAI MOTOR COMPANY, Seoul (KR); KIA CORPORATION, Seoul (KR)

(21) Appl. No.: 18/822,987

(22) Filed: Sep. 3, 2024

(30) Foreign Application Priority Data
Mar. 15, 2024 (KR) 10-2024-0036546

(51) Int. Cl. B60L 58/26; B60H 1/00; B60K 11/02; H01M 10/613; H01M 10/625; H01M 10/633; H01M 10/635; H01M 10/6568

(52) U.S. Cl. CPC B60L 58/26; B60K 11/02; H01M 10/613; H01M 10/625; H01M 10/633; H01M 10/635; H01M 10/6568; B60H 1/00278; B60H 2001/00307; B60H 1/00921; B60H 2001/00928; B60L 2260/56; H01M 2220/20

(57) ABSTRACT

A vehicle thermal management system includes: a fluid transfer device that consumes power to perform a thermal management function, and a control unit that determines an operation mode of the fluid transfer device. In particular, the fluid transfer device operates in the determined operation mode based on an optimal control value derived using a control model for a predicted state value.

### CROSS REFERENCE TO RELATED APPLICATIONS

This application claims priority to Korean Patent Application No. 10-2024-0036546, filed Mar. 15, 2024, the entire contents of which are incorporated herein by reference.

### BACKGROUND

### 1. Technical Field

The present disclosure relates to a vehicle thermal management system for performing thermal management for a vehicle.

### 2. Description of the Related Art

As interest in the environment has been growing recently, the number of eco-friendly vehicles equipped with an electric motor as a power source is increasing. Eco-friendly vehicles are also called electrified vehicles, and representative examples include hybrid electric vehicles (HEVs) and electric vehicles (EVs).

Electrified vehicles may have various components such as batteries and motors for propulsion. Because the operating performance of these components is affected by temperature, there is desired to consider not only interior air conditioning but also the requirements for components in terms of thermal management.

In particular, in the case of batteries, reversible and irreversible heat generation occurs due to internal chemical reactions when discharging or charging, and thus if any problem relating to battery heat generation is not resolved, the output and lifespan of a battery may be affected. In addition, battery output and charging performance may deteriorate at low temperatures. Therefore, in order to drive a vehicle stably and efficiently, it is desired to manage the temperature of a battery within an appropriate temperature range rather than at low or high temperature.

The description provided above as a related art of the present disclosure is just for helping understand the background of the present disclosure and should not be construed as being included in the related art known by those having ordinary skill in the art.

### SUMMARY

The present disclosure is proposed to solve the above problems, and the present disclosure provides a vehicle thermal management system that efficiently performs battery thermal management by using optimal control techniques.

The objectives of the present disclosure are not limited to those mentioned above, and other objectives not mentioned should be clearly understood by those having ordinary skill in the art from the description below.

In order to achieve the objective of the present disclosure, there is provided a vehicle thermal management system. In one embodiment of the present disclosure, the vehicle thermal management system may include: a fluid transfer device configured to have a thermal management function to manage temperature of a vehicle battery through heat exchange between an internally circulating fluid and the battery and consume power to perform the thermal management function. The vehicle thermal management system may further include: a control unit configured to determine an operation mode of the fluid transfer device based on the temperature of the battery and a preset reference temperature, and configured to operate the fluid transfer device in the determined operation mode based on an optimal control value derived using a control model for a predicted state value according to a current state value. In particular, the optimal control value may be a control value that allows the fluid transfer device to consume minimal power and establish a target battery temperature for temperature management of the battery while satisfying constraints that are determined to be satisfied based on the temperature of the battery.

In one embodiment, the control unit may determine the operation mode of the fluid transfer device based on the temperature of the battery and an external temperature outside a vehicle when the temperature of the battery is higher than the preset reference temperature.

In one embodiment, the fluid may include: coolant that exchanges heat with the battery; and refrigerant that exchanges heat with the coolant. The operation mode may include: a first cooling mode in which the battery is cooled by absorbing heat from the battery using the coolant and discharging the absorbed heat to an outside of the vehicle; and a second cooling mode in which the battery is cooled by absorbing heat from the battery using the coolant and releasing the absorbed heat into the refrigerant. The control unit may determine the operation mode to be one of the first cooling mode and the second cooling mode when the temperature of the battery is higher than the external temperature in the case where the temperature of the battery is higher than the preset reference temperature.

In one embodiment, the control unit may determine which of the first cooling mode and the second cooling mode has lower power consumption during a preset prediction range as the operation mode of the fluid transfer device.

In one embodiment, the control unit may determine a cooling mode corresponding to a smaller value, among values of a first cost function and a second cost function, as the operation mode of the fluid transfer device. The first cost function is for power consumption during the preset prediction range when operating the fluid transfer device in the first cooling mode, and the second cost function is for power consumption during the preset prediction range when operating the fluid transfer device in the second cooling mode.

In one embodiment, the values of the first cost function and the second cost function may mean respective minimum values of the first cost function and the second cost function.

In one embodiment, the control unit may determine the minimum values of the first cost function and the second cost function using the control model for the predicted state value according to the current state value.

In one embodiment, the fluid transfer device may include: a blowing device that regulates an amount of external air flowing into the fluid transfer device; and at least one pump that regulates a flow rate of coolant flowing toward the battery. The first cost function may be determined based on power consumption of at least one of i) the blowing device when regulating the amount of the external air flowing into the fluid transfer device, or ii) the at least one pump when regulating the flow rate of the coolant flowing toward the battery.

In one embodiment, the fluid transfer device may include: a blowing device that regulates an amount of external air flowing into the fluid transfer device; at least one pump that regulates a flow rate of coolant flowing toward the battery; and a compressor that regulates a flow rate of refrigerant. The second cost function may be determined based on power consumption of at least one of i) the blowing device when regulating the amount of the external air flowing into the fluid transfer device, ii) the at least one pump when regulating the flow rate of the coolant flowing toward the battery, or iii) the compressor when regulating the flow rate of the refrigerant.

In one embodiment, the fluid transfer device may further include at least one pump that regulates a flow rate of coolant flowing into a vehicle part other than the battery, and the second cost function may be determined by further considering power consumption of the at least one pump when regulating the flow rate of the coolant flowing into the vehicle part other than the battery.

In one embodiment, the control unit may redetermine the operation mode at each preset control point by comparing the first cost function and the second cost function.

In one embodiment, in the case where the cooling mode corresponding to a smaller value, among values of the first cost function and the second cost function based on a next control point, is different from the cooling mode determined as a current operation mode, the control unit may change the operation mode when a difference between the values of the first cost function and the second cost function based on the next control point is greater than a preset reference value.

In one embodiment, the fluid may include: coolant that exchanges heat with the battery; and refrigerant that exchanges heat with the coolant. The operation mode may include: a first cooling mode for cooling the battery by absorbing heat from the battery through the coolant and discharging the absorbed heat to an outside of the vehicle; and a second cooling mode for cooling the battery by absorbing heat from the battery through the coolant and releasing the absorbed heat into the refrigerant. The control unit may determine the operation mode to be the second cooling mode when the temperature of the battery is below the external temperature in the case where the temperature of the battery is higher than the preset reference temperature.

In one embodiment, the fluid may include coolant that exchanges heat with the battery, the operation mode may include a temperature raising mode for raising the temperature of the battery by means of a heater that heats the coolant. The control unit may determine the operation mode to be the temperature raising mode when the temperature of the battery is below the preset reference temperature.

In one embodiment, the control unit may determine the operation mode to be the temperature raising mode when the temperature of the battery is below the preset reference temperature and a state of charge (SOC) of the battery is higher than a preset reference SOC.

In one embodiment, the control model for the predicted state value may further reflect at least one of an influence of a current control value or an influence of a disturbance on a current output value.

In one embodiment, the control unit may derive the optimal control value based on a target value that allows the fluid transfer device to consume minimal power and perform the thermal management function. In particular, the target value may be derived based on a control model for an output value and a power consumption according to a state value and a control value.

In one embodiment, the target value may be determined in a steady state with no change in the state value.

In one embodiment, the control unit may determine a control value that minimizes a cost function for power consumption during a preset prediction range of the determined operation mode as the optimal control value.

In one embodiment, the optimal control value may be a physical quantity that affects the temperature of the battery according to operation results of the fluid transfer device, and the control unit may convert the optimal control value into an operating amount that determines an operation of the fluid transfer device, and control the fluid transfer device based on the operating amount.

According to the various embodiments of the present disclosure as described above, by appropriately selecting operation mode for thermal management of a battery, including temperature raising mode and cooling mode, the battery can be managed within a stable temperature range.

In particular, energy efficiency in battery thermal management can be improved since battery thermal management is performed by selecting a cooling mode with low power consumption among cooling modes by using optimal control techniques.

Furthermore, by reducing the energy used for thermal management, driving efficiency of a vehicle can be improved.

The effect of the present disclosure is not limited to that described above, and other effects not mentioned should be clearly understood by those having ordinary skill in the art from the description below.

### BRIEF DESCRIPTION OF THE DRAWINGS

FIG. 1 is a diagram schematically illustrating a fluid transfer device of a thermal management system applicable to embodiments of the present disclosure;

FIG. 2 is a block diagram schematically illustrating a vehicle thermal management system according to an embodiment of the present disclosure;

FIG. 3 is a block diagram illustrating an optimal control process of a control unit according to an embodiment of the present disclosure;

FIG. 4 is a diagram illustrating a first cooling mode of a fluid transfer device according to an embodiment of the present disclosure;

FIG. 5 is a diagram illustrating a second cooling mode of a fluid transfer device according to an embodiment of the present disclosure;

FIG. 6 is a diagram illustrating a temperature raising mode of a fluid transfer device according to an embodiment of the present disclosure; and

FIG. 7 is a flowchart showing the process of performing vehicle thermal management according to an embodiment of the present disclosure.

The drawings described herein are for illustration purposes only and are not intended to limit the scope of the present disclosure in any way.

### DETAILED DESCRIPTION

Specific structural and functional descriptions of embodiments of the present disclosure disclosed in this specification or application are merely illustrative for the purpose of explaining the embodiments according to the present disclosure. The embodiments according to the present disclosure may be implemented in various forms and should not be construed as limited to the embodiments described in this specification or application.

Since the embodiments according to the present disclosure may make various changes and have various forms, specific embodiments illustrated in the drawings and the specification are not intended to limit the present disclosure to the specific embodiments. Instead, according to the concept of the present disclosure, specific forms, and all changes, equivalents, and replacements thereof should be understood as being included in the spirit and scope of the present disclosure.

Unless otherwise defined, all terms herein, including technical or scientific terms, have the same meaning as commonly understood by those having ordinary skill in the art. Terms such as those defined in the commonly used dictionaries should be construed as having meanings consistent with the meanings in the context of the related art and shall not be construed in ideal or excessively formal meanings unless expressly defined in the present disclosure.

Hereafter, the embodiments of the present disclosure are described in detail with reference to the accompanying drawings, and the same or similar components are given the same reference numerals regardless of the numbers of figures and are not repeatedly described.

In the description of the following embodiments, the term “preset” means that the value of the parameter is predetermined when using the parameter in a process or algorithm. Depending on the embodiment, the numerical value of the parameter may be set when the process or algorithm starts or may be set during the period in which the process or algorithm is performed.

The suffixes “module” and “unit” that are used for components in the following description are given or used interchangeably only for the ease of writing the specification, and do not have distinct meanings or roles in themselves.

In the following description, if it is decided that the detailed description of known technologies related to the present disclosure makes the subject matter of the embodiment described herein unclear, the detailed description is omitted. Furthermore, the accompanying drawings are provided only for easy understanding of the embodiment disclosed in the specification, and the technical spirit disclosed in the specification is not limited by the accompanying drawings, and all changes, equivalents, and replacements should be understood as being included in the spirit and scope of the present disclosure.

Terms including ordinal numbers such as “first”, “second”, etc. may be used to describe various components, but the components are not to be construed as being limited to the terms. The terms are used only to distinguish one component from another component.

It is to be understood that when one element is referred to as being “connected to” or “coupled to” another element, it may be connected directly to or coupled directly to another element or be connected to or coupled to another element, having the other element intervening therebetween. On the other hand, it should be understood that when one element is referred to as being “connected directly to” or “coupled directly to” another element, it may be connected to or coupled to another element without the other element intervening therebetween.

Singular forms are intended to include plural forms unless the context clearly indicates otherwise.

Terms “comprise,” “include” or “have,” used in this specification, specify the presence of stated features, steps, operations, components, parts, or a combination thereof, but do not preclude the presence or addition of one or more other features, numerals, steps, operations, components, parts, or a combination thereof.

In addition, the terms “unit” or “control unit” included in motor control unit (MCU), hybrid control unit (HCU), etc. are just widely used terms for naming controllers that control specific vehicle functions, and do not mean generic function units.

A controller may include a communication device that communicates with another controller or a sensor to control corresponding functions, a memory that stores an operating system or logic commands and input/output information, and one or more processors that perform determination, calculation, decision, etc. for controlling the corresponding functions.

When a component, device, element, or the like of the present disclosure is described as having a purpose or performing an operation, function, or the like, the component, device, or element should be considered herein as being “configured to” meet that purpose or to perform that operation or function.

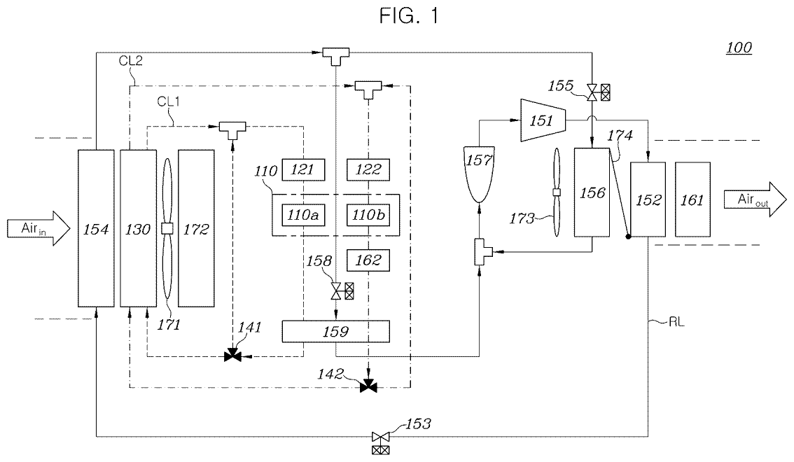

Below, before describing the operation of a control unit for performing thermal management of a vehicle according to an embodiment of the present disclosure, an example of implementation of a fluid transfer device applicable to the embodiments of the present disclosure is first described with reference to FIG. 1.

FIG. 1 is a diagram schematically illustrating a fluid transfer device of a thermal management system applicable to embodiments of the present disclosure.

Referring to FIG. 1, the fluid transfer device 100 of a thermal management system may perform vehicle thermal management such as cooling or raising the temperature of one or more vehicle parts 110, air conditioning of the vehicle interior (cabin), etc.

For this purpose, the fluid transfer device 100 may be provided with coolant lines CL1 and CL2 to exchange heat between the vehicle parts 110, and a refrigerant line RL to exchange heat between coolant and ambient air.

In one embodiment, the fluid transfer device 100 may be provided with a plurality of coolant lines CL1 and CL2, and the coolant lines CL1 and CL2 may individually exchange heat with individual vehicle parts 110 for thermal management of the different vehicle parts 110.

The vehicle parts 110 may include a drive system 110a such as a motor and an inverter, and a battery 110b. However, in the embodiments of the present disclosure, the vehicle parts 110 are not necessarily limited to the above examples and may include various parts that require heat dissipation. For example, the vehicle parts 110 may include various types of controllers (not shown) h such as an autonomous driving controller, a motor controller, a vehicle controller, and a controller involved in performing integrated thermal management according to an embodiment of the present disclosure.

Although FIG. 1 shows the coolant line CL1 for thermal management of the drive system 110a and the coolant line CL2 for thermal management of the battery 110b, the coolant lines CL1 and CL2 may be replaced with coolant lines for thermal management of other vehicle parts 110, such as a controller, or may coexist with coolant lines for thermal management of other vehicle parts 110. In addition, examples of implementation of the fluid transfer device 100 may include various cases, such as when only a single coolant line is provided for thermal management of one vehicle part 110, when multiple vehicle parts 110 are connected in series to one coolant line, etc.

Pumps 121 and 122 may be provided in the coolant lines CL1 and CL2, respectively, for circulation of coolants, and the pumps 121 and 122 may send coolants toward the vehicle parts 110. The pumps 121 and 122 may be implemented as, for example, an electric water pump (EWP) that circulates coolant by driving a motor using electrical energy.

The coolants flowing into the vehicle parts 110 through the pumps 121 and 122 may absorb heat generated from the vehicle parts 110 through heat exchange while passing through the vehicle parts 110, thereby cooling the vehicle parts 110.

The coolants that have passed through the vehicle parts 110 may flow toward a radiator 130. In the process of passing through the radiator 130, the coolants release the heat absorbed from the vehicle parts 110 to the surroundings, and flow back into the vehicle parts 110.

In this case, the radiator 130 may be provided individually for each of the coolant lines CL1 and CL2. In one embodiment, the radiators 130 corresponding to the coolant lines CL1 and CL2 may be divided into a high-temperature radiator and a low-temperature radiator.

The refrigerant line RL may be provided with a compressor 151, a plurality of condensers 152 and 153, a plurality of expanders 153, 155, 158, an evaporator 156, an accumulator 157, and a heat absorber 159. With this configuration, the fluid transfer device 100 may perform a heat pump function.

The compressor 151 consumes power to implement a heat pump function through circulation of refrigerant and may discharge the refrigerant at high temperature and high pressure.

The refrigerant that has passed through the compressor 151 passes through the indoor condenser 152, the expander 153, the outdoor condenser 154, the expander 155, the evaporator 156, and the accumulator 157, while repeating heat dissipation and heat absorption to/from the surroundings.

In particular, the refrigerant line RL may pass through the coolant lines CL1 and CL2 to recover waste heat of the vehicle parts 110 from the coolant lines CL1 and CL2, and may exchange heat with the coolant lines CL1 and CL2 through the heat absorber 159 connected to the coolant lines CL1 and CL2. Unlike that shown in FIG. 1, the fluid transfer device 100 may be provided with a plurality of heat absorbers 159, and the plurality of heat absorbers 159 may be connected to different coolant lines CL1 and CL2.

Meanwhile, to perform vehicle thermal management for different purposes, the fluid transfer device 100 may form various heat transfer paths by means of the coolant lines CL1 and CL2.

As an example, the coolant line CL1 for thermal management of the drive system 110a may form a heat transfer path for radiating heat absorbed from the drive system 110a to the outside through the radiator 130 and may form a heat transfer path for transferring heat absorbed from the drive system 110a to the refrigerant line RL through the heat absorber 159, and such heat transfer paths may be formed simultaneously.

The above heat transfer paths may be varied depending on a flow direction of coolant, and the flow direction of the coolant may be adjusted by a valve 141 provided in the coolant line CL1. Furthermore, circulation of the coolant may be suppressed by stopping operation of the pump 121 to prevent heat generated in the drive system 110a from flowing out through the radiator 130 or the heat absorber 159.

As another example, the coolant line CL2 for thermal management of the battery 110b may form a heat transfer path for radiating heat absorbed from the battery 110b to the outside through the radiator 130 and may form a heat transfer path that does not pass through the radiator 130. In particular, in the heat transfer path that does not pass through the radiator 130, as refrigerant circulates in the refrigerant line RL, heat generated in the battery 110b is transferred to the refrigerant line RL through the heat absorber 159, thereby cooling the battery 110b, or instead of transferring heat to the refrigerant line RL, the heat of coolant whose temperature is raised by a heater 162 that heats the coolant is transferred to the battery 110b, thereby raising the temperature of the battery 110b. The above heat transfer paths may vary depending on a flow direction of coolant, and the flow direction of the coolant may be adjusted by a valve 142 provided in the coolant line CL2.

The fluid transfer device 100 may recover heat generated from the vehicle parts 110, i.e., waste heat, through a heat transfer path, among the above heat transfer paths, for transferring the heat absorbed from the vehicle parts 110 to the refrigerant line RL through the heat absorber 159, and may recycle the recovered heat for cabin thermal management, etc., thereby improving the energy efficiency in vehicle thermal management.

Meanwhile, the fluid transfer device 100 may also exchange heat with external air, and the heat absorbed from the external air may be used for thermal management. In one embodiment, the heat exchange with the external air may be performed indirectly through the radiator 130, but may also be performed through an external evaporator (not shown) that absorbs heat from the external air.

In performing such thermal management, the fluid transfer device 100 may control the air flow from outside to inside, and may be equipped with a blowing device, an opening and closing device, etc. to control the air flow.

In one embodiment, the blowing device may include a cooling fan 171 for controlling the inflow of external air, and a blower 173 for controlling the discharge of air into the vehicle cabin. The opening and closing device may include, for example, an air flap 172 for controlling the inflow of external air and a temp door 174 for controlling the discharge of air into the cabin. The blowing device and the opening and closing device may consume power to operate.

In addition, the fluid transfer device 100 may include an electric heating device for raising the temperature of air or coolant. The electric heating device may include a heater 161 for heating air discharged into the vehicle cabin. In this case, the heater 161 may be a positive temperature coefficient (PTC) heater. As described above, the electric heating device may include a heater 162 that heats coolant to increase the temperature of the battery 110b.

According to the structure of the fluid transfer device 100 as described above, thermal management of a vehicle may be performed in various ways. In particular, various thermal management scenarios may be derived depending on the interior condition of the vehicle, the external condition of the vehicle, the condition of the vehicle parts 110a and 110b, etc.

FIG. 1 schematically illustrates the components of the fluid transfer device 100 applicable to embodiments of the present disclosure, and the actual fluid transfer device 100 may be implemented by including more or fewer components.

In addition, the fluid transfer device 100 described with reference to FIG. 1 represents an implementation example applicable to embodiments of the present disclosure. Thus, the fluid transfer device 100 according to embodiments of the present disclosure is not necessarily limited to what has been described above.

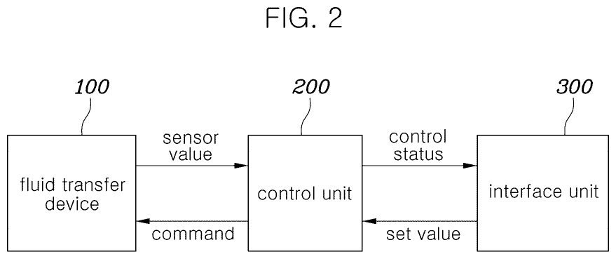

FIG. 2 is a block diagram schematically illustrating a vehicle thermal management system according to an embodiment of the present disclosure.

Referring to FIG. 2, a vehicle thermal management system according to an embodiment of the present disclosure may include: a fluid transfer device 100, a control unit 200, and an interface unit 300. However, FIG. 2 schematically illustrates components related to an embodiment of the present disclosure, and the actual thermal management system may be implemented by including more or fewer components.

The fluid transfer device 100 may be implemented as in the example described with reference to FIG. 1, and the control unit 200 may be implemented as an algorithm for performing a vehicle thermal management function, a memory configured to store data for software instructions that execute such algorithm, a processor configured to perform operations described below using data stored in the memory, and a controller having the same, etc.

In this case, the control unit 200 may be implemented as one integrated controller or a specific controller provided in a vehicle. In one embodiment, the control unit 200 may be implemented as a combination of multiple controllers. For example, the control unit 200 may be implemented as a combination of: a higher-level controller that performs judgments or calculations necessary for vehicle thermal management and generates control commands; and lower-level controllers that receive control commands from the higher-level controller and respectively control the components of the fluid transfer device 100.

The interface unit 300 may receive set values (i.e., input set values), etc. from a vehicle user (e.g., a driver) and transmit the set values to the control unit 200, and may receive information such as control status from the control unit 200 and display the received information in a visual or auditory manner. To this end, the interface unit 300 may be implemented as an instrument cluster, an audio, video, navigation, telematics (AVNT) device, or as a terminal of a vehicle user such as a driver.

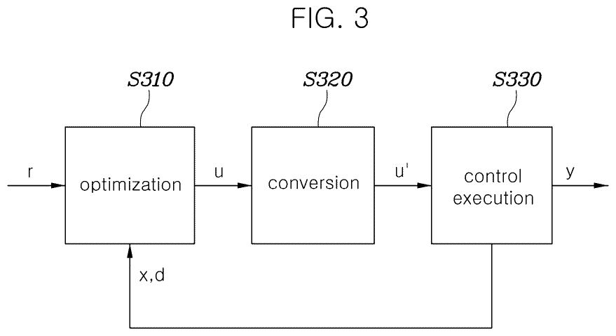

According to an embodiment of the present disclosure, the control unit 200 may perform optimal control for vehicle thermal management, as described below with reference to FIG. 3.

FIG. 3 is a block diagram illustrating an optimal control process of a control unit according to an embodiment of the present disclosure.

Referring to FIG. 3, the control unit 200 according to an embodiment of the present disclosure may perform vehicle thermal management through optimization (an operation S310), conversion (an operation S320), and control execution (an operation S330) processes.

In the operation S310, the optimization may be performed on a model basis. For example, proportional-integral-differential (PID) control, linear-quadratic-regulator (LQR) control, etc. may be used for optimization, and in particular, the optimization (in the operation S310) according to an embodiment of the present disclosure may be performed through model-based predictive control (MPC).

To be specific, the optimization (in the operation S310) process through model-based predictive control may be performed to basically reduce future errors in deriving an optimal control value (u) that allows an output value (y) to follow a target value (r).

To this end, the optimal control value (u) may be derived using a control model for a predicted state value according to a current state value (x). In other words, the optimal control value (u) may be derived by considering not only the current state but also the predicted future state.

In the control model for the predicted state value, in addition to the current state value (x), at least one of the current control value (u) or disturbance (d) may be further reflected, which may be expressed, for example, as in the equation below.

$${x}_{k + 1} = {A}_{k} {x}_{k} + {B}_{k} {u}_{k} + {B}_{w , k} {w}_{k} + {B}_{ϕ , k}$$

In the above equation, xₖ and xₖ₊₁ mean the current state value and predicted state value, and wₖ means the disturbance. Aₖ, Bₖ, B_{w,k} represent the influence of the current state, control input, and disturbance on the future state, respectively, and B_{φ,k} is a term that reflects the uncertainty of prediction.

By utilizing such a control model for a predicted state value, the predicted future state may be reflected in deriving the optimal control value.

In the optimization process (S310), optimization of the target value (r) may also be performed prior to deriving the optimal control value (u). In this case, optimization for the target value (r) may be performed in a steady state, and a control model for an output value may be utilized here. The control model for the output value represents a current state value and an output value according to a current control value, and may be expressed, for example, as the equation below.

$$[ \begin{matrix}{A}_{k} - I & {B}_{k} \\ {C}_{k} & 0\end{matrix} ] [ \begin{matrix}{x}_{s s} \\ {u}_{ss}\end{matrix} ] = [ \begin{matrix}- ( {B}_{w , k} {w}_{k} + {B}_{ϕ , k} ) \\ r\end{matrix} ]$$

In the above equation, xₛₛ and uₛₛ mean the state value and control value in the steady state, and wₖ means the disturbance. Aₖ, Bₖ, B_{w,k} represent the influence of the current state, control input, and disturbance on the future state, respectively, Cₖ represents the influence of the state value on the output value, and r may mean a target value, that is, an output value that is the target of control. B_{φ,k} is a term that reflects the uncertainty of prediction.

Alternatively, in an embodiment, the target value (r) optimization process in the steady state may be omitted. In this case, optimization may be performed such that the output value follows the target value in a dynamic state with changes in state value.

Meanwhile, in the optimization (S310) process through model-based predictive control, the optimal control value (u) may be derived from a cost function for a preset prediction range.

At this time, the preset prediction range refers to how far into the future to predict and may be expressed as a prediction horizon. As the prediction range increases, optimization performance may improve. However, as the prediction range increases, the computational load of the control unit 200 for prediction may increase.

In an embodiment, the optimal control value may be determined as a control value that minimizes the cost function for the preset prediction range as above, and in this case, the cost function may reflect a state cost with a weight on the state value and a control input cost with a weight on the control value. In addition, a final state cost with a weight on the final state value of the prediction range and a control change cost with a weight on the change in the control value may be further considered. The above cost function may be expressed, for example, as the equation below.

$$J ( {U}_{K} ) = {x}_{N}^{T} {Q}_{f} {x}_{N} + {\sum }_{i = 0}^{N - 1} ( {‖ {x}_{k + i} - {x}_{ss , k} ‖}_{Q}^{2} + {‖ {u}_{k + i} - {u}_{ss , k} ‖}_{R}^{2} + {‖ Δ {u}_{k + i} ‖}_{{R}_{du}}^{2} )$$

In the above equation, J(Uₖ) is a cost function, and the optimal control value may be determined as the control value corresponding to the current point among the control values (Uₖ) that minimize J(Uₖ).

xₖ₊ᵢ and x_{ss,k} respectively correspond to the prediction state value for the prediction range and the target state value for outputting the target value (r), and in the control process using the optimal control value (u), xₖ₊ᵢ changes in the direction to follow x_{ss,k}. At this time, ∥xₖ₊ᵢ−x_{ss,k}∥_{Q}² is a term that reflects the cost for the state value and is related to the speed at which the predicted state value reaches the target state value, and the larger the weight Q, the faster the predicted state value reaches the target state value. That is, the larger the weight Q, the better the control target tracking performance and the faster the control target may be achieved.

uₖ₊ᵢ and u_{ss,k} correspond to the prediction control value for the prediction range and the target control value for outputting the target value (r), and in the control process using the optimal control value (u), uₖ₊ᵢ changes to follow u_{ss,k}. At this time, ∥uₖ₊ᵢ−u_{ss,k}∥_{R}² is a term that reflects the cost for the control value and is related to the speed at which the predicted control value reaches the target control value, and the larger the weight R, the more energy consumed in the process of the predicted state value reaching the target state value may be reduced. In other words, the larger the weight R, the better the energy performance of control, allowing the control goal to be achieved with less energy.

Meanwhile, x_{N} refers to the final state value of the preset prediction range, and Q_{f} represents the weight for the final state value. At this time, x_{N}^{T} [symbol] _{f}x_{N} is a term that reflects the cost for the final state and may be applied to ensure the stability of prediction due to a finite prediction range.

∥Δuₖ₊ᵢ∥_{R}_{_{du}}² is a term that reflects the cost of change in control value, and R_{du} represents the weight of the change in control value. The cost of change in the control value may be applied to limit excessive change in the control value during the target value tracking process.

The control value may be optimized in the dynamic state where the state value (x) changes. In other words, the optimal control value (u) may be derived from the dynamic state. In this case, both the target value (r) and the optimal control value (u) may be optimized in the dynamic state (i.e., 1 stage), or the target value (r) may be optimized in the steady state and the optimal control value (u) may be optimized in the dynamic state (i.e., 2 stages).

The optimal control value (u) derived as above may be a physical quantity that affects vehicle thermal management depending on the operation of each component of the fluid transfer device 100, such as the mass flow rate of refrigerant or coolant, or the mass flow rate of air. In this case, the control unit 200 may convert the optimal control value (u) derived as a physical quantity through the conversion process (in the operation S320) into an operating amount (u′) such as rotational speed and duty for controlling the operation of the fluid transfer device 100. However, the optimal control value (u) is not necessarily limited to the above form, and may have various forms depending on each configuration of the fluid transfer device 100. In this case, when conversion to operating quantity is unnecessary, the conversion process (the operation S320) may be omitted.

After the above optimization (the operation S310) and conversion (the operation S320) are performed, actual control of the components of the fluid transfer device 100 is performed according to the optimal control value (u) and the corresponding operating amount (u′), and the results of control execution may appear in the form of output value (y). At this time, the output value (y) may be collected through various sensors installed in the vehicle, converted to a physical quantity if necessary, and then transmitted back to the control unit 200. In this case, the control unit 200 may determine the current state (x) and disturbance (d) according to the output value (y), and these may be reflected again in optimization (S310).

Referring back to FIG. 2, the vehicle thermal management system according to an embodiment of the present disclosure improves the efficiency of vehicle thermal management by determining the operation mode of the fluid transfer device 100 based on the temperature of the battery 110b and a preset reference temperature, and by operating the fluid transfer device 100 in a determined operation mode based on the optimal control value derived using a control model for the predicted state value according to the current state value.

For this purpose, the thermal management system according to an embodiment may include: the fluid transfer device 100 that is equipped with a thermal management function to manage the temperature of the vehicle battery 110b through heat exchange between the internally circulating fluid and the battery 110b and that consumes power to perform the thermal management function. The thermal management system may further include: the control unit 200 that determines an operation mode of the fluid transfer device 100 based on the temperature of the battery 110b and a preset reference temperature and that operates the fluid transfer device 100 in the determined operation mode based on the optimal control value derived using a control model for the predicted state value according to the current state value.

In more detail, the optimal control value may be a control value that allows the fluid transfer device 100 to consume minimal power and establish a target battery temperature for temperature management of the battery 110b while satisfying constraints that are determined to be satisfied based on the temperature of the battery 110b. In addition, the constraints, which are determined to be satisfied based on the temperature of the battery 110b, may be satisfied when the temperature of the battery 110b is within a temperature range at which the battery 110b may operate normally, and the target battery temperature may fall within this range.

When the temperature of the battery 110b is higher than the reference temperature, the control unit 200 may determine the operation mode of the fluid transfer device 100 based on the temperature of the battery 110b and the external temperature outside the vehicle. At this time, the reference temperature may serve as a standard for determining whether the battery 110b needs to be cooled or heated, and may be set in various ways depending on the specifications of the battery, etc.

To be specific, the fluid circulating inside the fluid transfer device 100 may include: a coolant that exchanges heat with the battery 110b, and a refrigerant that exchanges heat with the coolant. In this case, the operation mode may include: a first cooling mode in which the battery is cooled by absorbing heat from the battery 110b using coolant and discharging the absorbed heat to the outside of the vehicle; and a second cooling mode in which the battery is cooled by absorbing heat from the battery 110b using coolant and releasing the absorbed heat into the refrigerant.

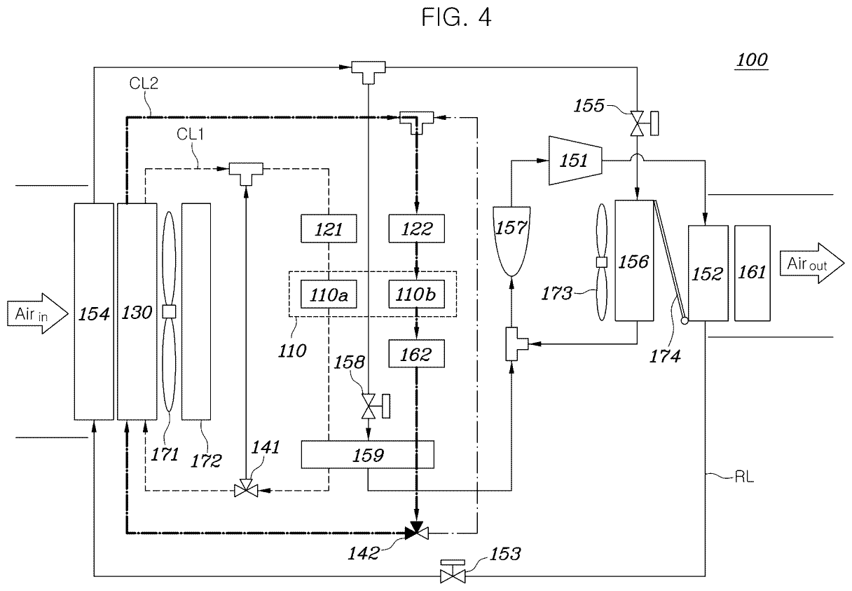

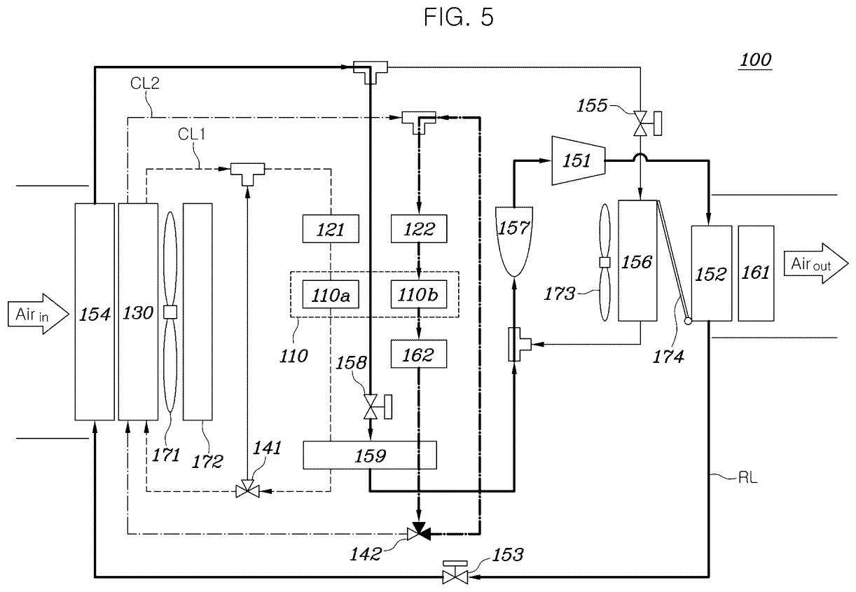

Based on the configuration of the fluid transfer device 100 shown in FIG. 1, the fluid flow according to the operation of the fluid transfer device 100 in the first cooling mode may be expressed as shown in FIG. 4, and the fluid flow according to the operation of the fluid transfer device 100 in the second cooling mode may be expressed as shown in FIG. 5.

In the case where the temperature of the battery 110b is higher than the reference temperature, when the temperature of the battery 110b is higher than the external temperature, the control unit 200 may determine the operation mode to be one of the first cooling mode and the second cooling mode. Since both the first cooling mode and the second cooling mode may be applied, the more efficient cooling method is selected when the temperature of the battery 110b is higher than the external temperature.

To this end, the control unit 200 may determine which one of the first cooling mode and the second cooling mode has lower power consumption during a preset prediction range as the operation mode of the fluid transfer device 100.

To be specific, the control unit 200 may determine the cooling mode corresponding to the smaller value, among values of a first cost function and a second cost function, as the operation mode of the fluid transfer device 100. The first cost function is for power consumption during the preset prediction range when operating the fluid transfer device 100 in the first cooling mode, whereas the second cost function is for power consumption during the preset prediction range when operating the fluid transfer device 100 in the second cooling mode. In other words, when selecting an operation mode among the first cooling mode and the second cooling mode, a cost function for power consumption may be used. In this case, the values of the first cost function and the second cost function may mean their respective minimum values. In other words, by comparing the minimum power consumption expected to be consumed in performing thermal management of the battery 110b during the prediction range according to each cooling mode, the cooling mode that enables thermal management of the battery 110b with lower power consumption is determined as the operation mode of the fluid transfer device 100.

At this time, the control unit 200 may determine the minimum values of the first cost function and the second cost function using a control model for the predicted state value according to the current state value.

In another embodiment, the fluid transfer device 100 may include: a blowing device 171 that controls the amount of external air flowing into the fluid transfer device 100; and at least one pump 122 that controls the flow rate of coolant flowing toward the battery. The number and arrangement positions of the blowing device 171 and pump 122 may vary depending on a specific embodiment. Depending on the configuration of the fluid transfer device 100, the external air introduced through the blowing device 171 may contribute to the cooling of the battery 110b in various ways, such as indirectly contributing to the cooling of the battery 110b by exchanging heat with the coolant that cools the battery 110b, directly contributing to the cooling of the battery 110b by exchanging heat with the battery 110b itself, or exchanging heat with the coolant that cools the battery 110b while simultaneously exchanging heat with the battery 110b itself.

At this time, the first cost function may be determined based on the power consumptions of at least one of i) the blowing device 171 that controls the amount of external air flowing into the fluid transfer device 100 or ii) the at least one pump 122 that controls the flow rate of coolant flowing toward the battery 110b. The first cost function may be expressed, for example, as the equation below.

$${P}_{1} = {\sum }_{k = 0}^{N - 1} ( {P}_{fan} ( k ) + {P}_{ewp} ( k ) )$$

In the above equation, P₁ refers to the first cost function, k refers to the next point in time relative to the current point in time, N refers to the final point in the prediction range, P_{fan}(k) refers to the power consumption of the blowing device 171 that regulates the amount of external air flowing into the fluid transfer device 100, and P_{ewp}(k) refers to the power consumption of the at least one pump 122 that regulates the flow rate of coolant flowing toward the battery 110b.

In addition, the fluid transfer device 100 may include the compressor 151 that regulates the flow rate of the refrigerant. In this embodiment, the second cost function may be determined based on at least one of the power consumptions of i) the blowing device 171 that regulates the amount of external air flowing into the fluid transfer device 100, ii) the at least one pump 122 that regulates the flow rate of coolant flowing toward the battery 110b, and iii) the compressor 151 that regulates the flow rate of the refrigerant.

Furthermore, the fluid transfer device 100 may further include at least one pump 121 that regulates the flow rate of coolant flowing into the vehicle parts 110 other than the battery 110b. In this embodiment, the second cost function may be determined by further considering the power consumption of the at least one pump 121 that regulates the flow rate of coolant flowing into the vehicle parts 110 other than the battery 110b. At this time, the vehicle parts 110 other than the battery 110b may include a drive system 110a, a controller (not shown), etc. The second cost function may be expressed, for example, as the equation below.

$${P}_{2} = {\sum }_{k = 0}^{N - 1} ( {P}_{fan} ( k ) + {P}_{ewp} ( k ) + {P}_{ewp}^{′} ( k ) + {P}_{comp} ( k ) )$$

In the above equation, P₂ refers to the first cost function, k refers to the next point in time relative to the current point in time, N refers to the final point in the prediction range, P_{fan}(k) refers to the power consumption of the blowing device 171 that regulates the amount of external air flowing into the fluid transfer device 100, P_{ewp}(k) refers to the power consumption of the at least one pump 122 that regulates the flow rate of coolant flowing toward the battery 110b, P′_{ewp}(k) refers to the power consumption of the at least one pump 121 that regulates the flow rate of coolant flowing into the vehicle parts 110 other than the battery 110b, and P_{comp}(k) refers to the power consumption of the compressor 151 that regulates the flow rate of the refrigerant.

The values of the first cost function and the second cost function may be determined under constraints on the temperature of the battery 110b, and a control model for the predicted state value may be used in the determination.

In one embodiment, the control unit 200 may redetermine the operation mode at each preset control point by comparing the first cost function and the second cost function. Thus, based on the next control point, if thermal management through a different cooling mode is more energy efficient than the cooling mode determined as the current operation mode, the operation mode may be changed. At this time, control point is the stage of prediction from the current point to the future point, and it can be understood that the prediction range is from the current point to the final control point.

For example, the control unit 200 may change the operation mode when the cooling mode corresponding to the smaller value, among values of the first cost function and the second cost function based on the next control point, is different from the cooling mode determined as the current operation mode.

However, when the cooling mode corresponding to the smaller value, among values of the first cost function and the second cost function based on the next control point, is different from the cooling mode determined as the current operation mode, the control unit 200 may prevent frequent mode changes by changing the operation mode when the difference between the values of the first cost function and the second cost function based on the next control point is greater than a preset reference value. For example, assuming that the current operation mode is the first cooling mode, when the value of the first cost function is greater than the value of the second cost function based on the next control point and the difference is equal to or less than the reference value, the control unit 200 may maintain the operation mode of the fluid transfer device 100 in the first cooling mode.

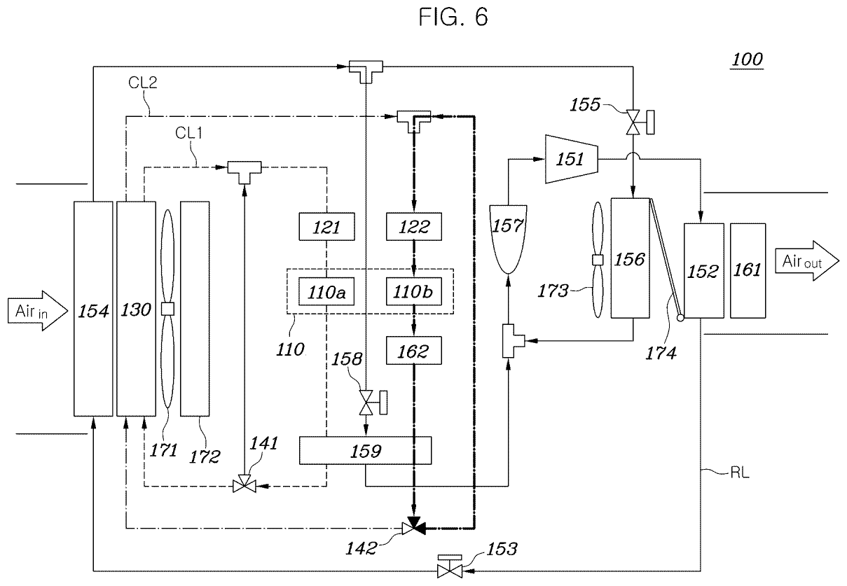

Meanwhile, when the temperature of the battery 110b is higher than the reference temperature and lower than the external temperature, the control unit 200 may determine the operation mode to be the second cooling mode. Based on the configuration of the fluid transfer device 100 as shown in FIG. 1, the fluid flow according to the operation of the fluid transfer device 100 in a temperature raising mode may be expressed as shown in FIG. 6.

In this case, because the temperature of the battery 110b is lower than the external temperature, there are limitations in performing the first cooling mode of cooling the battery 110b by means of the external temperature, the second cooling mode, which is an available cooling mode, is determined as the operation mode of the fluid transfer device 100.

The operation mode of the fluid transfer device 100 may include the temperature raising mode in which the battery 110b is heated by the heater 162 that heats the coolant. When the temperature of the battery 110b is below a preset reference temperature, the control unit 200 may determine the operation mode to be the temperature raising mode.

However, even if the temperature of the battery 110b is below the preset reference temperature, the control unit 200 may determine the operation mode to be the temperature raising mode only when the state of charge (SOC) of the battery 110b is higher than a preset reference SOC, and due to this, the battery 110b may be managed within an appropriate Soc range. In this case, the reference Soc may be set in various ways depending on the type, specification, durability status, etc. of the battery 110b.

Meanwhile, once the operation mode is determined, the control unit 200 may determine a control value that reduces or minimizes the cost function for power consumption during a preset prediction range of the determined operation mode as the optimal control value. In other words, a cost function for power consumption may be used not only in selecting an operation mode, but also in operating the fluid transfer device 100 in the selected operation mode, and due to this, the energy efficiency of thermal management of the battery 110b may be improved.

Hereinafter, the process of vehicle thermal management described so far is further explained with reference to a flowchart.

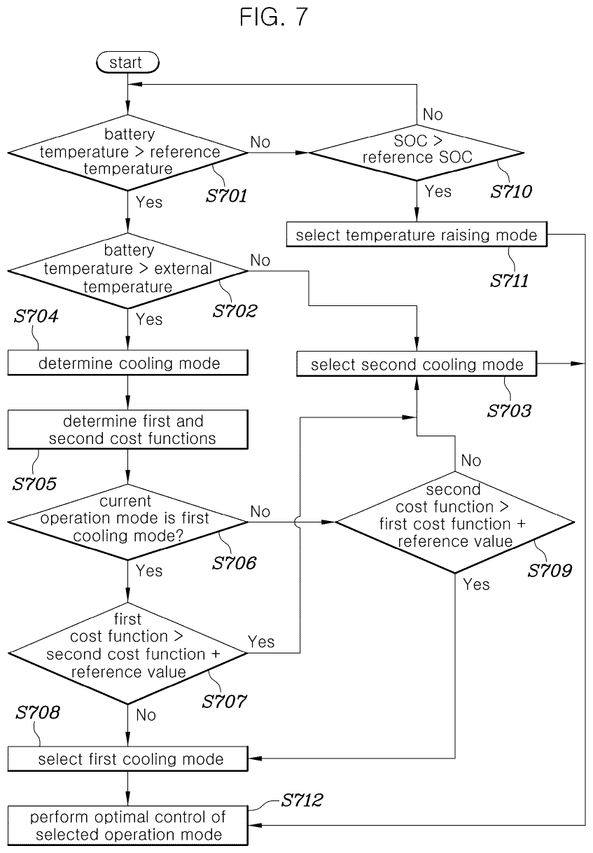

FIG. 7 is a flowchart showing the process of performing vehicle thermal management according to an embodiment of the present disclosure.

Referring to FIG. 7, the control unit 200 may determine whether to operate the fluid transfer device 100 in a cooling mode or a temperature raising mode based on the temperature of the battery 110b and the reference temperature (an operation S701).

When the temperature of the battery 110b is higher than the reference temperature (Yes in the operation S701), the control unit 200 may determine that it is necessary to operate the fluid transfer device 100 in a cooling mode and determine which cooling mode to use as the operation mode based on the temperature of the battery 110b and the external temperature (an operation S702).

When the temperature of the battery 110b is below the external temperature (No in the operation S702), cooling through external air is limited, and thus the control unit 200 may determine the second cooling mode as the operation mode of the fluid transfer device 100 (an operation S703).

When temperature of the battery 110b exceeds the external temperature (Yes in the operation S702), there are no limitations on cooling through external air, and thus the control unit 200 determines which of the first cooling mode and the second cooling mode is determined as the operation mode of the fluid transfer device 100 in an operation S704. In other words, when temperature of the battery 110b exceeds the external temperature, the control unit 200 determines whether the first cooling mode or the second cooling mode should be the operation mode of the fluid transfer device.

In an operation S705, the control unit 200 may compare the first cost function for the first cooling mode and the second cost function for the second cooling mode to determine the operation mode.

In the case where the currently determined operation mode is the first cooling mode (Yes in an operation S706), when the value of the first cost function is greater than the value of the second cost function by more than the preset reference value (Yes in an operation S707), the control unit 200 may change the operation mode to the second cooling mode (an operation 703). On the contrary, when the value of the first cost function is no greater than the value of the second cost function by more than the preset reference value (No in the operation S707), the control unit 200 may maintain the operation mode in the first cooling mode without changing the operation mode to the second cooling mode (in an operation S708).

Similarly, in the case where the currently determined operation mode is the second cooling mode (No in the operation S706), when the value of the second cost function is greater than the value of the first cost function by more than the preset reference value (Yes in the operation S709), the control unit 200 may change the operation mode to the first cooling mode. On the contrary, when the value of the second cost function is no greater than the value of the first cost function by more than the preset reference value (No in the operation S709), the control unit 200 may maintain the operation mode in the second cooling mode without changing the operation mode to the first cooling mode.

When the current operation mode is neither the first cooling mode nor the second cooling mode, the control unit 200 may determine the operation mode only by comparing the first cost function and the second cost function without considering the reference value.

Meanwhile, When the temperature of the battery 110b is below the reference temperature (No in the operation S701), the control unit 200 may compare the current SOC of the battery 110b with the reference SOC (in an operation S710) to determine whether the temperature raising mode operation is possible. In this case, if the current SOC exceeds the reference SOC (Yes in the operation S710), the control unit 200 may select the temperature raising mode as the operation mode of the fluid transfer device 100 (in an operation S711).

After the operation mode is selected, the control unit 200 operates the fluid transfer device 100 in the selected operation mode based on the optimal control value (in an operation S712). In this case, the control unit 200 may control the fluid transfer device 100 by setting a control value that minimizes the cost function for power consumption during a preset prediction range of the selected operation mode as the optimal control value.

According to the various embodiments of the present disclosure as described above, by appropriately selecting an operation mode for thermal management of a battery, including temperature raising mode and cooling mode, the battery may be managed within a stable temperature range.

In particular, energy efficiency in the battery thermal management may be improved since the battery thermal management is performed by selecting a cooling mode with low power consumption among cooling modes by using optimal control techniques.

Furthermore, by reducing the energy used for thermal management, driving efficiency of a vehicle may be improved.

Although the present disclosure was provided above in relation to specific embodiments shown in the drawings, it is apparent to those having ordinary skill in the art that the present disclosure may be changed and modified in various ways without departing from the scope of the present disclosure, which is provided in the following claims.

What is claimed is:

1. A vehicle thermal management system comprising:
a fluid transfer device configured to have a thermal management function to manage temperature of a vehicle battery through heat exchange between an internally circulating fluid and the battery; and
a control unit configured to determine an operation mode of the fluid transfer device based on the temperature of the battery and a preset reference temperature, and configured to operate the fluid transfer device in the determined operation mode based on an optimal control value derived using a control model for a predicted state value according to a current state value,
wherein the optimal control value is a control value that allows the fluid transfer device to consume minimal power and establish a target battery temperature for temperature management of the battery while satisfying constraints that are determined to be satisfied based on the temperature of the battery.

2. The thermal management system of claim 1, wherein the control unit is configured to determine the operation mode of the fluid transfer device based on the temperature of the battery and an external temperature outside a vehicle in response that the temperature of the battery is higher than the preset reference temperature.

3. The thermal management system of claim 2, wherein the fluid comprises: coolant configured to exchange heat with the battery; and refrigerant configured to exchange heat with the coolant,
wherein the operation mode comprises:
a first cooling mode in which the battery is cooled by absorbing heat from the battery using the coolant and discharging the absorbed heat to an outside of the vehicle; and
a second cooling mode in which the battery is cooled by absorbing heat from the battery using the coolant and releasing the absorbed heat into the refrigerant, and
wherein the control unit determines the operation mode to be one of the first cooling mode and the second cooling mode in response that the temperature of the battery is higher than the external temperature and the temperature of the battery is higher than the preset reference temperature.

4. The thermal management system of claim 3, wherein the control unit is configured to determine which of the first cooling mode and the second cooling mode has lower power consumption during a preset prediction range as the operation mode of the fluid transfer device.

5. The thermal management system of claim 4, wherein the control unit is configured to determine a cooling mode corresponding to a smaller value, among values of a first cost function and a second cost function, as the operation mode of the fluid transfer device, and
wherein the first cost function is for power consumption during the preset prediction range when operating the fluid transfer device in the first cooling mode, and the second cost function is for power consumption during the preset prediction range when operating the fluid transfer device in the second cooling mode.

6. The thermal management system of claim 5, wherein the values of the first cost function and the second cost function are respective minimum values of the first cost function and the second cost function.

7. The thermal management system of claim 6, wherein the control unit is configured to determine the minimum values of the first cost function and the second cost function using the control model for the predicted state value according to the current state value.

8. The thermal management system of claim 5, wherein the fluid transfer device comprises: a blowing device configured to regulate an amount of external air flowing into the fluid transfer device; and at least one pump configured to regulate a flow rate of coolant flowing toward the battery, and
wherein the first cost function is determined based on power consumption of at least one of the blowing device when regulating the amount of the external air flowing into the fluid transfer device, or the at least one pump when regulating the flow rate of the coolant flowing toward the battery.

9. The thermal management system of claim 5, wherein the fluid transfer device comprises: a blowing device configured to regulate an amount of external air flowing into the fluid transfer device; at least one pump configured to regulate a flow rate of coolant flowing toward the battery; and a compressor configured to regulate a flow rate of refrigerant, and
wherein the second cost function is determined based on power consumption of at least one of: the blowing device when regulating the amount of the external air flowing into the fluid transfer device, the at least one pump when regulating the flow rate of the coolant flowing toward the battery, or the compressor when regulating the flow rate of the refrigerant.

10. The thermal management system of claim 9, wherein the fluid transfer device further comprises at least one pump configured to regulate a flow rate of coolant flowing into a vehicle part other than the battery, and
the second cost function is determined further based on power consumption of the at least one pump when regulating the flow rate of the coolant flowing into the vehicle part other than the battery.

11. The thermal management system of claim 5, wherein the control unit is configured to redetermine the operation mode at each preset control point by comparing the first cost function and the second cost function.

12. The thermal management system of claim 11, wherein when the cooling mode corresponding to a smaller value, among values of the first cost function and the second cost function based on a next control point, is different from the cooling mode determined as a current operation mode, the control unit is configured to change the operation mode in response that a difference between the values of the first cost function and the second cost function based on the next control point is greater than a preset reference value.

13. The thermal management system of claim 1, wherein:
the fluid comprises:
coolant configured to exchange heat with the battery, and
refrigerant configured to exchange heat with the coolant;
the operation mode comprises:
a first cooling mode for cooling the battery by absorbing heat from the battery through the coolant and discharging the absorbed heat to an outside of the vehicle, and
a second cooling mode for cooling the battery by absorbing heat from the battery through the coolant and releasing the absorbed heat into the refrigerant; and
the control unit is configured to determine the operation mode to be the second cooling mode when the temperature of the battery is below an external temperature and the temperature of the battery is higher than the preset reference temperature.

14. The thermal management system of claim 1, wherein:
the fluid comprises coolant configured to exchange heat with the battery,
the operation mode comprises a temperature raising mode for raising the temperature of the battery by a heater configured to heat the coolant, and
the control unit is configured to determine the operation mode to be the temperature raising mode when the temperature of the battery is below the preset reference temperature.

15. The thermal management system of claim 14, wherein the control unit is configured to determine the operation mode to be the temperature raising mode when the temperature of the battery is below the preset reference temperature and a state of charge (SOC) of the battery is higher than a preset reference SOC.

16. The thermal management system of claim 1, wherein the control model for the predicted state value further reflects at least one of an influence of a current control value or an influence of a disturbance on a current output value.

17. The thermal management system of claim 1, wherein the control unit is configured to derive the optimal control value based on a target value that allows the fluid transfer device to consume minimal power and perform the thermal management function,
wherein the target value is derived based on a control model for an output value and a power consumption according to a state value and a control value.

18. The thermal management system of claim 17, wherein the target value is determined in a steady state with no change in the state value.

19. The thermal management system of claim 1, wherein the control unit is configured to determine a control value that minimizes a cost function for power consumption during a preset prediction range of the determined operation mode as the optimal control value.

20. The thermal management system of claim 1, wherein the optimal control value is a physical quantity that affects the temperature of the battery according to operation results of the fluid transfer device, and
the control unit is configured to:
convert the optimal control value into an operating amount that determines an operation of the fluid transfer device, and
control the fluid transfer device based on the operating amount.
